(19) United States
(12) Patent Application Publication
(10) Pub. No.: US 2003/0155848 A1
(43) Pub. Date: Aug. 21, 2003

(54) Illumination tube and LCD device for use therewith

(75) Inventors: Yi-Shiuan Chiou, Taipei (TW); Ming-Shen Sun, Hsinchu (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU OPTRONICS CORP.

(21) Appl. No.: 10/367,531

(22) Filed: Feb. 14, 2003

(30) Foreign Application Priority Data
Feb. 15, 2002 (TW) 91102577

(51) Int. Cl. H01K 1/26; H01K 1/30; H01J 5/16; H01J 61/40

(52) U.S. Cl. 313/110

(57) ABSTRACT

An illumination tube. The illumination tube includes a transparent tube, a reflecting layer, a phosphor and a plurality of electrodes. The transparent tube has a wall. The reflecting layer has an opening and is formed on a part of the wall of the transparent tube. The phosphor is formed in the transparent tube and covers the reflecting layer. The electrodes are disposed in the transparent tube. When the phosphor emits light by discharging the electrodes, the light is guided to the opening by the reflecting layer and transmitted via the opening.

### BACKGROUND OF THE INVENTION

1. Field of the Invention

The present invention relates to an illumination tube, and in particular to an illumination tube enhancing illumination of an LCD device.

2. Description of the Related Art

FIG. 1 is a schematic view showing a conventional illumination tube 10. The conventional illumination tube 10 includes a transparent tube 1, two electrodes 2a and 2b disposed in the transparent tube 1, and a phosphor 3 formed in the transparent tube 1.

When the conventional illumination tube 10 emits light, the light is emitted from the outer surface of the illumination tube 10 uniformly to form a circular light field. FIG. 2 is a schematic view showing a conventional illumination tube 10 in combination with a reflecting hood 4. When the illumination tube 10 illuminates a certain area, the light emitted from the outer surface of the illumination tube 10 is transmitted to the area uniformly by the reflecting hood 4.

Nevertheless, the reflecting hood 4 increases the volume of the illumination tube 10. Furthermore, the illumination tube 10 having the reflecting hood 4 increases the thickness of an LCD device.

### SUMMARY OF THE INVENTION

An object of the present invention is to provide an illumination tube. The illumination tube comprises a transparent tube, a reflecting layer, a phosphor and a plurality of electrodes. The transparent tube has an inner wall. The reflecting layer has an opening and is formed on the inner wall of the transparent tube. The phosphor is formed in the transparent tube and covers the reflecting layer. The plurality of electrodes are disposed in the transparent tube. The phosphor emits light by discharging the electrodes, and the light is guided to the opening by the reflecting layer and transmitted via the opening.

Another object of the present invention is to provide an LCD device. The LCD device comprises a light-guiding plate, an LCD panel, a reflecting plate and an illumination tube. The light-guiding plate has a first surface, a second surface and a light-receiving surface. The first surface is opposite to the second surface, and the light-receiving surface is located laterally to the light-guiding plate and adjacent to the first surface and the second surface. The LCD panel is disposed on the second surface of the light-guiding plate. The reflecting plate is disposed under the first surface of the light-guiding plate. The illumination tube has a transparent tube, a reflecting layer, a phosphor and a plurality of electrodes. The transparent tube has an inner wall. The reflecting layer is formed on the inner wall and has an opening. The phosphor is formed in the transparent tube and covers the reflecting layer. The electrodes are disposed in the transparent tube. The illumination tube is disposed on the light-receiving surface of the light-guiding plate, and the opening faces the light-receiving surface.

When the illumination tube lights, the phosphor emits light by discharging the electrodes, and the light is guided to the opening by the reflecting layer and transmitted via the opening. The light is transmitted to the light-receiving surface of the light-guiding plate via the opening, and is transmitted to the LCD panel uniformly by the light-guiding plate and the reflecting plate, so the LCD panel emits light uniformly.

A detailed description is given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a conventional illumination tube;

FIG. 2 is a schematic view showing a conventional illumination tube in combination with a reflecting hood;

FIG. 3A is a schematic view showing a longitudinal cross section of the first embodiment according to the present invention;

FIG. 3B is a schematic view showing a transverse cross section of the first embodiment according to the present invention;

FIG. 3C is a schematic view showing a longitudinal cross section of the second embodiment according to the present invention;

FIG. 3D is a schematic view showing a longitudinal cross section of the third embodiment according to the present invention;

FIG. 4 is a schematic view showing the LCD device for use with the illumination tube according to the present invention.

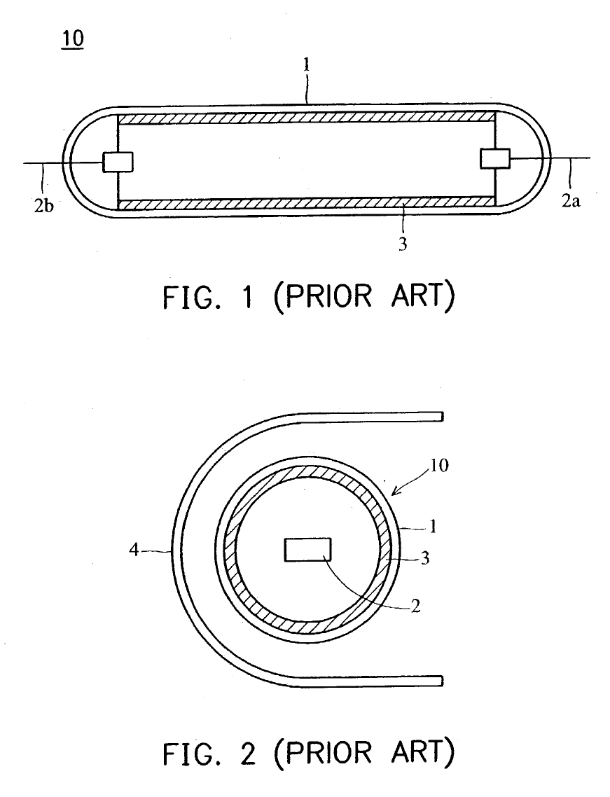

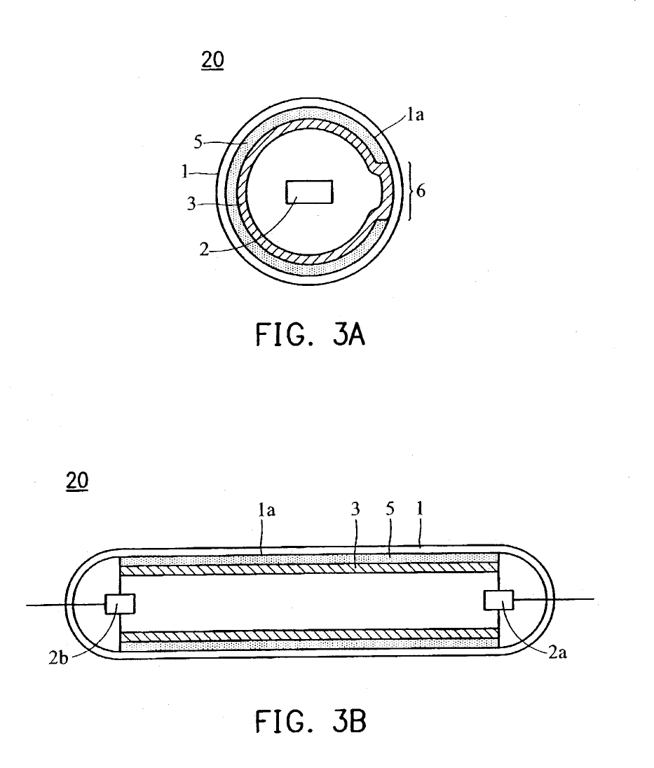

### DETAILED DESCRIPTION OF THE INVENTION

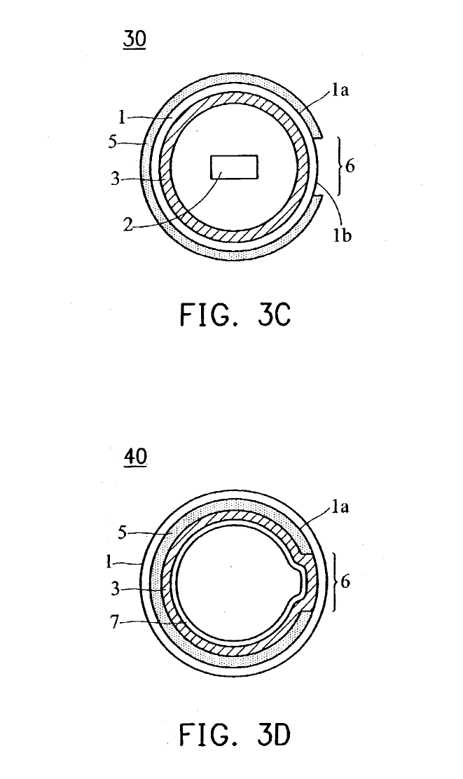

Referring to FIGS. 3A and 3B, the illumination tube 10 comprises a transparent tube 1, a phosphor 3, an electrode 2 (two electrodes 2a, 2b), and a reflecting layer 5.

The transparent tube 1 has an inner wall 1a. The reflecting layer 5 is formed on the inner wall 1a and has an opening 6. The phosphor 3 covers the reflecting layer 5 having the opening 6. The electrodes 2a, 2b are disposed on opposite sides of the transparent tube 1, as shown in FIG. 3B.

When the electrodes 2a and 2b discharge in the transparent tube 1, the phosphor 3 emits light. A part of the light is transmitted directly via the opening 6 while the other part of the light is guided to the opening 6 by the reflecting layer 5 and transmitted via the opening 6.

Referring to FIG. 3C, in the illumination tube 30, the reflecting layer 5 is formed on the outer wall 1b of the transparent tube 1 while the phosphor 3 is formed on the inner wall 1a of the transparent tube 1. Additionally, the reflecting layer 5 has an opening 6.

Referring to FIG. 3D, the illumination tube 40 further comprises a protection layer 7 formed on the phosphor 3.

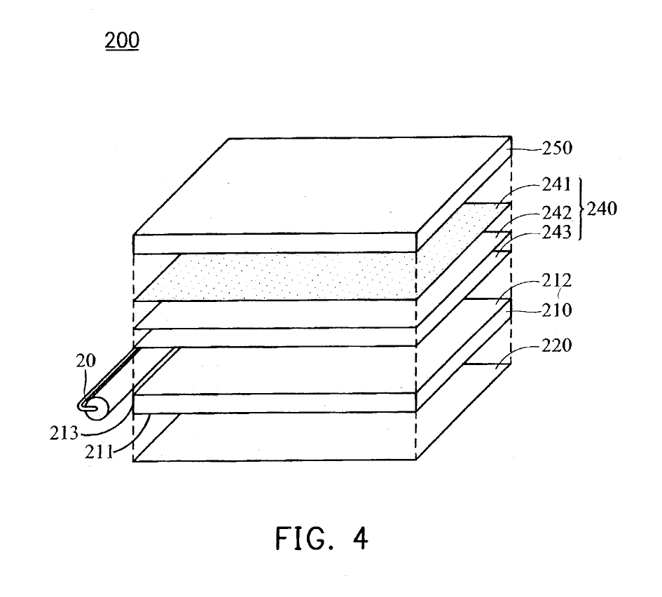

Referring to FIG. 4, the LCD device 200 comprises an LCD panel 250, a light-guiding plate 210, a reflecting plate 220 and an illumination tube 20. A diffusing means 240 is disposed between the LCD panel 250 and the light-guiding plate 210. The light-guiding plate 210 has a first surface 211, a second surface 212 and a light-receiving surface 213. The first surface 211 is opposite to the second surface 212, and the light-receiving surface 213 is located laterally to the light-guiding plate 210 and adjacent to the first surface 211 and the second surface 212. The illumination tube 20 is disposed beside the light-guiding plate 210, and the opening 6 faces the light-receiving surface 213. The reflecting plate 220 is disposed under the first surface 211. The light-guiding plate 210 is disposed between the LCD panel 250 and the reflecting plate 220.

As shown in FIG. 4, when the illumination tube 20 emits light, the light enters the light-receiving surface 213 of the light-guiding plate 210 via the opening 6. Then, the light is transmitted to the LCD panel 250 uniformly via the light-guiding plate 210, reflecting plate 220, and diffusing means 240. Therefore, the LCD panel 250 emits the light uniformly.

The diffusing means 240 disposed on the second surface 212 of the light-guiding plate 210 includes a diffusing sheet 241, a prism sheet 242, and a protection film 243. The protection film 243 is adjacent to the second surface 212 of the light-guiding plate 210, and the diffusing sheet 241 is adjacent to the LCD panel 250.

Specifically, after the reflecting layer 5 is formed on the inner wall 1a of the transparent tube 1 uniformly, the opening 6 is formed by laser blasting.

While the invention has been described by way of examples thereof and in terms of the preferred embodiments, it is to be understood that the invention is not limited to the disclosed embodiments. It is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An illumination tube, comprising:
a transparent tube having an inner wall;
a reflecting layer having an opening and formed on the inner wall of the transparent tube;
a phosphor formed in the transparent tube and covering the reflecting layer; and
a plurality of electrodes disposed in the transparent tube, wherein the phosphor emits light by discharging the electrodes, and the light is guided to the opening by the reflecting layer and transmitted via the opening.

2. The illumination tube as claimed in claim 1, further comprising a protection layer covering the phosphor.

3. The illumination tube as claimed in claim 1, wherein the reflecting layer is formed on the inner wall uniformly and the opening is formed by laser blasting.

4. An illumination tube, comprising:
a transparent tube having an inner wall and an outer wall;
a reflecting layer having an opening and formed on the outer wall of the transparent tube;
a phosphor formed on the inner wall of the transparent tube; and
a plurality of electrodes disposed in the transparent tube, wherein the phosphor emits light by discharging the electrodes, and the light is guided to the opening by the reflecting layer and transmitted via the opening.

5. The illumination tube as claimed in claim 4, further comprising a protection layer covering the phosphor.

6. An LCD device, comprising:
a light-guiding plate having a first surface, a second surface and a light-receiving surface, wherein the first surface is opposite to the second surface, and the light-receiving surface is located laterally to the light-guiding plate and adjacent to the first surface and the second surface;
an LCD panel disposed on the second surface of the light-guiding plate;
a reflecting plate disposed under the first surface of the light-guiding plate; and
an illumination tube having a transparent tube, a reflecting layer, a phosphor and a plurality of electrodes, the transparent tube having an inner wall, the reflecting layer formed on the inner wall and having an opening, the phosphor formed in the transparent tube and covering the reflecting layer, the electrodes disposed in the transparent tube, wherein the illumination tube is disposed on the light-receiving surface of the light-guiding plate, and the opening faces the light-receiving surface.

7. The LCD device as claimed in claim 6, further comprising a diffusing means disposed between the LCD panel and the light-guiding plate.

8. The LCD device as claimed in claim 7, wherein the diffusing means includes a protection film, a prism sheet and a diffusing sheet, the protection film disposed on the light-guiding plate.

9. The LCD device as claimed in claim 6, wherein the illumination tube further comprises a protection layer covering the phosphor.

10. The LCD device as claimed in claim 6, wherein the reflecting layer is formed on the inner wall uniformly and the opening is formed by laser blasting.

11. An LCD device, comprising:
a light-guiding plate having a first surface, a second surface and a light-receiving surface, wherein the first surface is opposite to the second surface, and the light-receiving surface is located laterally to the light-guiding plate and adjacent to the first surface and the second surface;
an LCD panel disposed on the second surface of the light-guiding plate;
a reflecting plate disposed under the first surface of the light-guiding plate; and
an illumination tube having a transparent tube, a reflecting layer, a phosphor and a plurality of electrodes, the transparent tube having an inner wall and an outer wall, the reflecting layer formed on the outer wall and having an opening, the phosphor formed on the inner wall, the electrodes disposed in the transparent tube, wherein the illumination tube is disposed on the light-receiving surface of the light-guiding plate and the opening faces the light-receiving surface.

12. The LCD device as claimed in claim 11, wherein the illumination tube further comprises a protection layer covering the phosphor.
